(19) United States
(12) Patent Application Publication
(10) Pub. No.: US 2008/0247584 A1
(43) Pub. Date: Oct. 9, 2008

(54) ELECTRONIC DEVICE WITH INTERNAL MICROPHONE ARRAY NOT PARALLEL TO SIDE EDGES THEREOF

(75) Inventors: Ming Zhang, Cupertino, CA (US); Wan-Chieh Pai, San Jose, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/696,325

(22) Filed: Apr. 4, 2007

(51) Int. Cl. H04R 19/04

(52) U.S. Cl. 381/357

(57) ABSTRACT

An electronic device includes a case and a microphone array. The case includes a front surface, a rear surface, and side edges connecting the front surface and the rear surface. The microphone array includes a first microphone module and a second microphone module disposed in the case and arranged in a row not parallel to the side edges of the case.

### BACKGROUND OF THE INVENTION

1. Field of the Invention

The invention relates to an electronic device, and more particularly to an electronic device with an internal microphone array not parallel to side edges thereof.

2. Description of the Related Art

A conventional microphone array includes a number of microphones disposed in tandem to clearly receive sound from a predetermined direction and avoid environmental noise. A simple example is shown in FIG. 1A, wherein the microphone array 150 includes two omnidirectional microphones 120 and 130 placed side by side in a line L. When beamforming is executed, sound arriving at the omnidirectional microphones 120 and 130 at the same time is unsuppressed, but that arriving at different times is suppressed. Thus, a so-called “pie” beam is obtained, wherein sound from source directions not perpendicular to the line L is suppressed, while sound from source directions perpendicular to the line L cannot be.

FIG. 1B depicts the microphone array 150 mounted in a cellphone, wherein two acoustic openings are provided on the front surface of cellphone 10 through which microphones 120 and 130 receive external sound. If the microphones 120 and 130 are disposed parallel to the bottom of the cellphone 120, sound from a near-end source at the front of the cellphone 10 is not suppressed. However, undesired sound (i.e. environment noise) P from the rear of the cellphone 10 is also not suppressed. Note that both source sound and sound P propagate perpendicular to the line connecting the microphones 120 and 130.

### BRIEF SUMMARY OF THE INVENTION

To avoid the described problem, the invention provides an electronic device with an internal microphone array not parallel to side edges thereof.

In an exemplary embodiment, the electronic device includes a case and a microphone array. The case includes a front surface, a rear surface, and side edges connecting the front surface and the rear surface. The microphone array includes a first microphone module and a second microphone module disposed in the case and arranged in a row not parallel to the side edges of the case.

The electronic device may further include a circuit board on which the first and second microphone modules are mounted.

The circuit board may be substantially parallel to the front and rear surfaces of the case.

The first and second microphone modules may include omnidirectional microphones.

In another exemplary embodiment, the electronic device includes a case and a microphone array. The case includes a first acoustic opening, a second acoustic opening, a front surface, a rear surface, and side edges connecting the front surface and the rear surface, wherein no side edges of the case are parallel to a line connecting the first acoustic opening and the second acoustic opening. The microphone array is disposed in the case, receiving external sound via the first and second acoustic openings.

The first acoustic opening may be formed on the front surface, while the second acoustic opening may be formed on the front surface or one of the side edges.

The electronic device may further include a circuit board on which the microphone array is mounted.

The circuit board may be substantially parallel to the front and rear surfaces of the case.

The microphone array may include omnidirectional microphones.

The electronic device may be a handheld device.

In another exemplary embodiment, a method of producing an electronic device is performed as follows.

First, a first microphone module and a second microphone module are attached to a circuit board by surface mount technology, with the first microphone module and the second microphone module arranged in a row.

Next, a case is provided, which comprises a front surface, a rear surface, and side edges connecting the front surface and the rear surface.

Finally, the circuit board is located in the case, with the row not parallel to the side edges of the case.

In another exemplary embodiment, a method of producing an electronic device is performed as follows.

First, a microphone array is attached to a circuit board by surface mount technology.

Next, a case is provided, which comprises a first acoustic opening, a second acoustic opening, a front surface, a rear surface, and side edges connecting the front surface and the rear surface, wherein no side edges of the case are parallel to a line connecting the first acoustic opening and the second acoustic opening.

Finally, the circuit board is located in the case.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic diagram of a typical microphone array;

FIG. 1B depicts the microphone array of FIG. 1A mounted in a cellphone;

FIG. 2A depicts a microphone array mounted in a cellphone in accordance with an embodiment of the invention;

FIG. 2B is a top view of the microphone array of FIG. 2A mounted on a circuit board;

FIG. 2C is a front view of the microphone array of FIG. 2A mounted on the circuit board;

FIG. 3A depicts a microphone array mounted in a cellphone in accordance with another embodiment of the invention;

FIG. 3B is a top view of the microphone array of FIG. 3A mounted on a circuit board;

FIG. 3C is a front view of the microphone array of FIG. 3A mounted on the circuit board;

FIGS. 4 and 5 depict two other embodiments of the invention, wherein the microphone array is located at a different corner of the case of the cellphone than that of the previous embodiments.

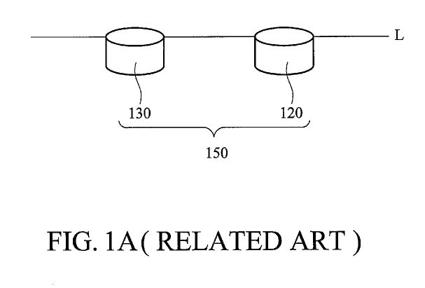

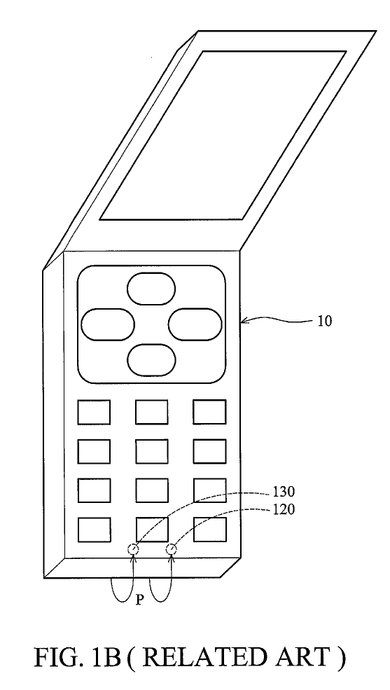

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

While a cellphone is used for description of the disclosure in the following descriptions, it is understood that the invention is equally applicable to a variety electronic devices including cellphones, personal digital assistants, and other handheld devices.

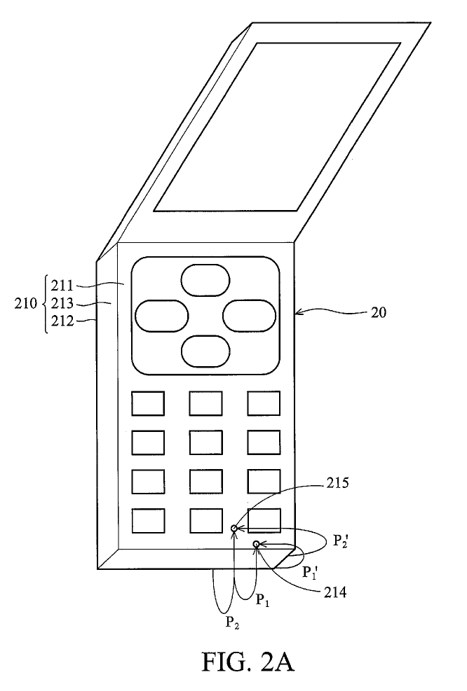

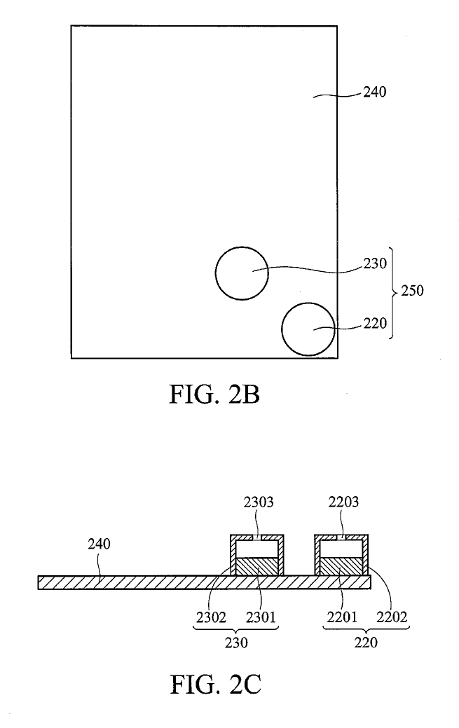

Referring to FIGS. 2A, 2B, and 2C, a cellphone 20 of an embodiment of the invention includes a case 210 with a microphone array 250 disposed therein. The case 210 includes a front surface 211, a rear surface 212, and side edges 213 connecting the front surface 211 and the rear surface 212. A first acoustic opening 214 and a second acoustic opening 215 are provided on the front surface 211 of the case 210.

The microphone array 250 includes a first microphone module 220 and a second microphone module 230 both of which are mounted on a circuit board 240 in the case 210 by, for example, surface mount technology (SMT). The circuit board 240 is substantially parallel to the front and rear surfaces 211 and 212 of the case 210. The first microphone module 220 has an omnidirectional microphone 2201 fitted into a rubber boot 2202. The rubber boot 2202 has a hole 2203 connected to the first acoustic opening 214 of the front surface 211 of the case 210 allowing the omnidirectional microphone 2201 to receive external sound. Similarly, the second microphone module 230 has an omnidirectional microphone 2301 fitted into a rubber boot 2302. The rubber boot 2302 has a hole 2303 connected to the second acoustic opening 215 of the front surface 211 of the case 210 allowing the omnidirectional microphone 2301 to receive external sound.

In operation, beamforming is executed in such a way that external sound arriving at the first and second microphone modules 220 and 230 at the same time is unsuppressed, but that arriving at different times is suppressed. In this embodiment, therefore, the first microphone module 220 and the second microphone module 230 are arranged in a row not parallel to the side edges 213 of the case 210. Such an arrangement can effectively avoid undesired sound (i.e. environmental noise). For example, sound waves from the rear of the cellphone 20 are suppressed because of a different arrival time, wherein the sound waves travel to the first microphone module 220 (indicated by arrows P₁ and P₁′) in a shorter path than to the second microphone module 230 (indicated by arrows P₂ and P₂′).

Furthermore, the arrangement of the first and second microphone modules 220 and 230 renders a line which connects the first acoustic opening 214 and the second acoustic opening 215 not parallel to the side edges 213 of the case 210.

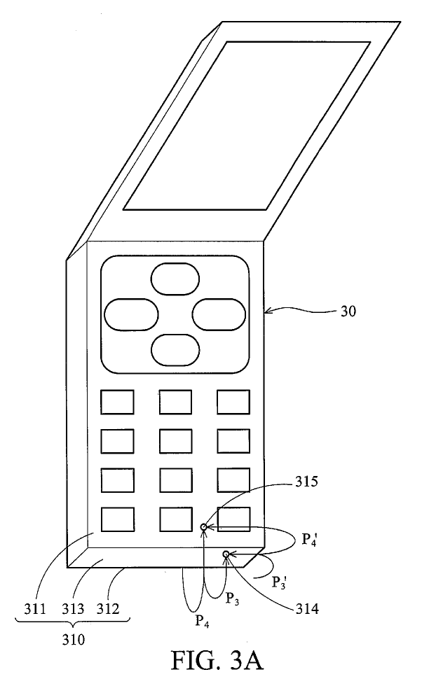

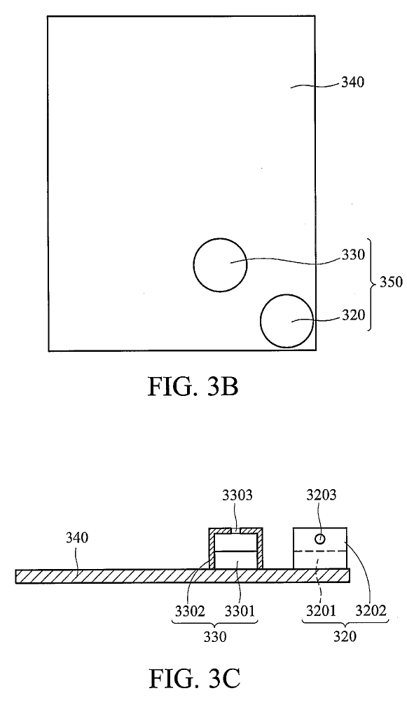

Referring to FIGS. 3A, 3B, and 3C, a cellphone 30 of another embodiment of the invention includes a case 310 with a microphone array 350 disposed therein. The case 310 includes a front surface 311, a rear surface 312, and side edges 313 connecting the front surface 311 and the rear surface 312. A first acoustic opening 314 and a second acoustic opening 315 are provided on the bottom (a side edge) 313 and the front surface 311 of the case 210, respectively.

The microphone array 350 includes a first microphone module 320 and a second microphone module 330 both of which are mounted on a circuit board 340 in the case 310 by, for example, surface mount technology (SMT). The circuit board 340 is substantially parallel to the front and rear surfaces 311 and 312 of the case 310. The first microphone module 320 has an omnidirectional microphone 3201 fitted into a rubber boot 3202. The rubber boot 3202 has a hole 3203 connected to the first acoustic opening 314 of the bottom 313 of the case 310 allowing the omnidirectional microphone 3201 to receive external sound. Similarly, the second microphone module 330 has an omnidirectional microphone 3301 fitted into a rubber boot 3302. The rubber boot 3302 has a hole 3303 connected to the second acoustic opening 315 of the front surface 311 of the case 310 allowing the omnidirectional microphone 3301 to receive external sound.

The microphone array 350 operates in such a way that external sound arriving at the first and second microphone modules 320 and 330 at the same time is unsuppressed, but that arriving at different times is suppressed. In this embodiment, therefore, the first microphone module 320 and the second microphone module 330 are arranged in a row not parallel to the side edges 313 of the case 310. Such an arrangement can effectively avoid some undesired sound. For example, sound waves from the rear of the cellphone 30 are suppressed because of different arrival time, wherein the sound waves travel to the first microphone module 320 (indicated by arrows P₃ and P₃′) in a shorter path than to the second microphone module 330 (indicated by arrows P₄ and P₄′).

Note that a line connecting the first acoustic opening 314 and the second acoustic opening 315 is not parallel to the side edges 313 of the case 310.

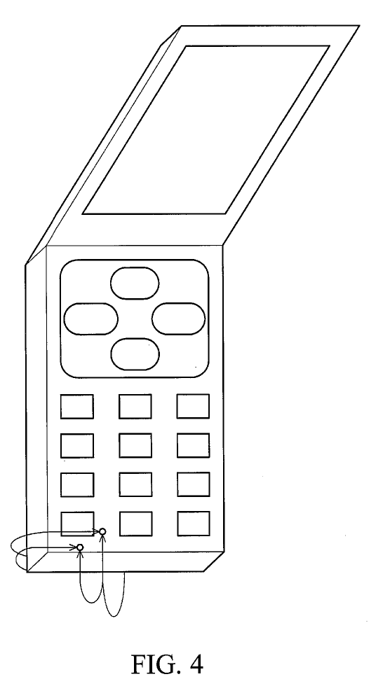

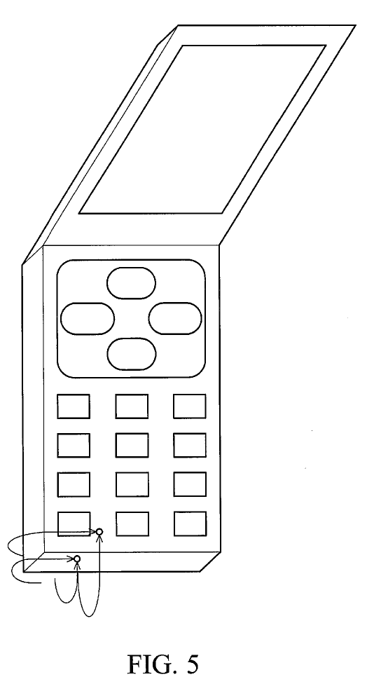

FIGS. 4 and 5 depict two other embodiments of the invention, wherein the microphone array is located at a different corner of the case of the cellphone, as compared to that of the previous embodiments.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a case comprising a front surface, a rear surface, and side edges connecting the front surface and the rear surface; and
a microphone array comprising a first microphone module and a second microphone module disposed in the case and arranged in a row not parallel to the side edges of the case.

2. The electronic device as claimed in claim 1, further comprising a circuit board on which the first and second microphone modules are mounted.

3. The electronic device as claimed in claim 2, wherein the circuit board is substantially parallel to the front and rear surfaces of the case.

4. The electronic device as claimed in claim 1, wherein the first and second microphone modules include omnidirectional microphones.

5. The electronic device as claimed in claim 1, wherein the electronic device is a handheld device.

6. An electronic device, comprising:
a case comprising a first acoustic opening, a second acoustic opening, a front surface, a rear surface, and side edges connecting the front surface and the rear surface, wherein no side edges of the case are parallel to a line connecting the first acoustic opening and the second acoustic opening; and
a microphone array disposed in the case, receiving external sound via the first and second acoustic openings.

7. The electronic device as claimed in claim 6, wherein the first and second acoustic openings are formed on the front surface.

8. The electronic device as claimed in claim 6, wherein the first acoustic opening is formed on the front surface and the second acoustic opening is formed on one of the side edges.

9. The electronic device as claimed in claim 6, further comprising a circuit board on which the microphone array is mounted.

10. The electronic device as claimed in claim 9, wherein the circuit board is substantially parallel to the front and rear surfaces of the case.

11. The electronic device as claimed in claim 6, wherein the microphone array includes omnidirectional microphones.

12. The electronic device as claimed in claim 6, wherein the electronic device is a handheld device.

13. A method of producing an electronic device, comprising:
attaching a first microphone module and a second microphone module to a circuit board by surface mount technology, with the first microphone module and the second microphone module arranged in a row;
providing a case which comprises a front surface, a rear surface, and side edges connecting the front surface and the rear surface; and
locating the circuit board in the case, with the row not parallel to the side edges of the case.

14. A method of producing an electronic device, comprising:
attaching a microphone array to a circuit board by surface mount technology;
providing a case which comprises a first acoustic opening, a second acoustic opening, a front surface, a rear surface, and side edges connecting the front surface and the rear surface, wherein no side edges of the case are parallel to a line connecting the first acoustic opening and the second acoustic opening; and
locating the circuit board in the case.
